(19) United States
(12) Patent Application Publication
(10) Pub. No.: US 2006/0168389 A1
(43) Pub. Date: Jul. 27, 2006

(54) Portable operating system

(76) Inventor: Carl M. Bentley, New York, NY (US)

Correspondence Address: LAWRENCE P. ZALE, 334 South Franklin Street, Wilkes-Barre, PA, 18703, US

(21) Appl. No.: 11/047,350

(22) Filed: Jan. 27, 2005

(51) Int. Cl. G06F 12/06

(52) U.S. Cl. 711/2

(57) ABSTRACT

A method for operating various host computers regardless of the type of operating system installed. A portable operating system is stored on read/write media such as a rewritable CD, DVD or jump memory drive (“R/W media”). The operating system is stored at a starting location on the R/W media to make it load into the host computer when it is started and load the operating system. Communications software may be pre-stored on the R/W device for remote access. The communications programs are executed to allow the user to log into a remote server to access the pre-stored data, applications and user preferences to give the user a standard ‘look and feel’ regardless of which host computer is used or the software and operating system installed on the host computer. The invention may also operate without communications programs in a local mode.

### BACKGROUND OF THE INVENTION

1. Field of the Invention

The present invention relates to computer operating systems, and more particularly to a computer operating system capable of being run on various host computers having different installed operating systems, or no operating system

2. Discussion of Prior Art

Typically, users have data, applications for accessing the data and user-defined preferences specific to a given user stored locally on their own personal computer. If a user were to take their data with them on a portable storage device, such as a CD, DVD or memory drive, and try to access their data using another computer at some remote location (a “host computer”), the proper applications may not be installed on the host computer, or if so, an incompatible version may be installed on the host computer. Even if the proper application and version is installed on the host computer, the user's specific preferences would have to be recentered into the host computer.

In another scenario, users may upload and store data on a central server. In the event that the user would like to access this data from a remote host computer, either the server or host computer must have the proper communications programs in addition to the proper application and version.

In order to access the data if stored on the remote server, the proper communication software must be used. Even if the user were to carry their communications programs with them, the communications programs may not be compatible with the installed operating system and/or hardware of the host computer,

Assuming the host computer has the proper software and hardware setup to log into a remoter server, the operating system and software uses ‘scratch’ areas on the hard drive of the host computer. This leaves scratch files, cache files, and other temporary files on the hard drive of the host computer. Since they are interacting over a communication line, which may be an Internet connection then ‘cookies’, history logs, and other Internet temporary files are created and stored on the host computer's hard drive.

Some operating systems are not as secure as others and allow viruses worms, Trojan horses, and adware to be stored on the host computer.

All information stored on the host computer disk as a result of the use by one other than the owner will be referred to as (“data tracks”) throughout the remainder of this document.

Additionally, in prior art systems the user may enter and change user-defined preferences of a previous user when using a host computer. This replaces the owner's user preferences. Therefore, the owner of the host computer must re-enter his/her own user preferences after the user has used the host computer. This becomes needless duplication of effort.

Therefore, for the reasons set forth above, the owner of the host computer would be reluctant to let a user use the host computer, even if the user is working on their own data.

There are also a number of problems which occur when the data/applications/user preferences are stored locally on the user's personal computer. These are:
a) data/software/user preference may be accidentally destroyed by authorized parties (“accidental data destruction”);
b) data/software/user preference may be destroyed by unauthorized parties (“intentional data destruction”); and
c) data/software/user preference being viewed or copied by unauthorized parties, both locally and remotely (“data theft”).
   a) Accidental Data Destruction

When the data/software/user preferences are stored locally, there is always the possibility of accidental damage from flooding, dropping the computer, power surge, bad hard drive, inadvertent deletions, etc. This could lead to traumatic results to the owner.

b) Intentional Data Destruction

Worms, viruses, Trojan Horses, and other destruction software may be hidden into executable programs accepted remotely over a network or the Internet. Once inside they may destroy data/programs/configuration files.

If a person is allowed local physical access to a computer, they may insert a program to do similar damage, or take the storage media and do the same at a different location.

c) Data Theft

A person may remotely gain access to a user's storage area and view or copy data without the user knowing that this has occurred.

Similarly, this may occur locally by physical access to a computer, wipe out the password file and view or copy any of the storage media.

This may also occur by the person stealing the storage media for some period of time, copying the information, then returning the unchanged media. The user may not be aware that the data has been viewed or stolen. This may cause considerable damage since passwords, bank account numbers, credit card numbers etc. may be stolen and used for a period of time before the user is aware that there is a problem.

There have been prior art attempts to allow the user to carry operating systems on storage media to run specific applications.

Some prior art game software used their own proprietary operating systems. Unfortunately, these were not general operating systems and did not allow the user to run other programs. They only allowed the user to run various compatible games, but not general purpose applications.

Certain disk disaster recovery applications employed operating systems on a recovery CD. This allowed the computer to boot up and run the disaster recovery applications; however they were not a general operating systems, and also used the scratch area on the host computer. Therefore, they left data tracks on the host computer.

Currently there is a need for a portable operating system which may be run on most host computers that allows user secure access to their own information without making any modifications to the host computer.

### SUMMARY OF THE INVENTION

In accordance with the present invention, a method of accessing a user's information in consistent manner from various host computers is described.

First removable read/write media (“R/W media”) capable of storing and providing digital information provided to it is acquired.

The R/W media is then initialized. It is initialized by selecting an operating system to be used by various host computers, and configuring the operating system so that the user may opt to prohibit writing to the host computers local storage devices, and instead writing to the R/W media, or if networked, a host computer. Alternatively, the user may also opt to allow writing to the host computer's local storage devices.

The configured operating system is then stored on the R/W media at a specific location/track/sector, hardware address, memory location, designated as a start location from which to load its memory, making the operating system bootable.

If the R/W device is intended to be used in a networked mode, communications software is also stored on the R/W device.

If the present invention is intended to only be used in a local mode, all of the required data and applications must be pre-stored on the R/W device.

A link is activated between the R/W media and the host computer during startup of the host computer. This causes the contents of the R/W media to be loaded into memory of the host computer.

The operating system in the memory of the host computer is then run to ‘boot up’ the host computer. The user then logs into the operating system.

If operating in the networked mode, the communications software is then run to link the host computer to a server.

The user now has access to the pre-stored data, applications and user preferences from one or more of the server, the R/W media and the host computer's local storage devices (if not prohibited) in the networked mode. In the local mode the user has access to the pre-stored data, applications and user preferences from either, or both, the R/W media and the host computer local storage devices (if not prohibited). This provides the user with a standard ‘look and feel’ regardless of which host computer is used or the software and operating system installed on the host computer.

In another embodiment of the present invention, a method of configuring removable read/write media (“R/W media”) so as to load a portable operating system on a host computer is described. The steps of the method are described below.

First, acquiring R/W media capable of storing digital information provided to it.

Then, selecting and configuring an operating system to allow a user to either a) prohibit, or b) allow writing to the host computers local storage devices.

Storing the configured operating system on the R/W media starting at specific location/track/sector, hardware address, memory location, designated as a start location from which it loads its memory, thereby making the operating system bootable.

Optionally, communications software and login information are also stored on the R/W media allowing the host computer to connect to a server and act as a terminal or access point to a larger more powerful system.

In another embodiment, the present invention may also be described as an access device allowing use of a host computer without changing the contents of the computer.

This embodiment includes removable read/write media capable of storing and providing digital information provided to it (“R/W media”),

a data link in data communication with the R/W media, capable of passing data to, and receiving data from the host computer, and

an operating system configured not to write to the host computer's local storage devices, and does its writing on the R/W media, pre-stored on the R/W media beginning at a location from which the host computer begins loading its internal memory upon start-up, making the operating system bootable.

### BRIEF DESCRIPTION OF THE DRAWINGS

A complete understanding of the present invention may be obtained by reference to the accompanying drawings, when considered in conjunction with the subsequent detailed description, in which:

FIG. 1 is a general schematic overview of an embodiment of the present invention.

FIG. 2 is a block diagram showing the operation of the present invention in the Networked Mode.

FIG. 3 is a block diagram showing the operation of the present invention in the Local Mode.

For purposes of brevity and clarity, like components and elements of the apparatus of this invention will bear the same designations or numbering throughout the figures.

### DESCRIPTION OF THE PREFERRED EMBODIMENT

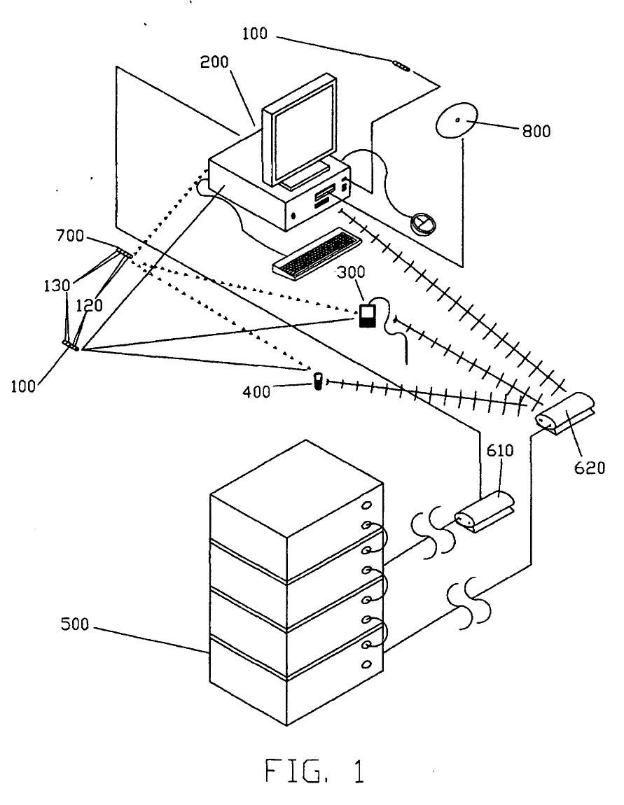

FIG. 1 is a general schematic overview of an embodiment of the present invention. In FIG. 1, a user carries with him/her a standard operating system on removable read/write storage media capable of storing and later providing the stored digital information. The storage media may be read/write CDs, (CDRW), read/write DVDs (DVD-RW) 800, or memory drives 100, 700 (flash drives or jump drives) having RAM memory 120 currently available, or any storage media being developed, or which may be developed in the future such as holographic, molecular, and quantum information storage media, all collectively referred to as (“R/W media”). The R/W media may also have portions which are read-only memory 130 such as ROM, PROM or EPROM. The read-only memory would be for storage of operating system executable code and other information which is not intended to change. The use of read-only memory for portions of the information makes the system more resistant to overwriting and crashing.

The present invention may be implemented in a local or networked mode.

A user gains access to a standard PC 200, PDA 300, digital cellular telephone 400 and other computing devices which has networking capabilities to use as a host computer.

The host computer 200, 300, 400 is shut down and R/W media device is inserted (in the case of a CDRW or DVD-RW 800), attached (in the case of a USB device 100), or linked (in the case of a device with a radiofrequency data link, or an infrared data link of memory drive 700) to the host computer.

Host computer 200, 300, 400 is then started. The host computer is designed (as is currently standard) to first look for inserted or attached media, and if present, then begin loading its memory from a specific memory address, hardware address, disk sector and track (“boot location”) on the R/W media 120.

The R/W media 120 is manufactured or configured specifically to be “bootable”, meaning that the proper instruction and any required ‘jumps’ to a proper memory location are stored at the proper boot locations on the R/W media at which the host computer 200, 300, 400 looks during startup. Once the host computer sees the proper codes at the proper locations on the R/W media 120, it then proceeds to load its memory with the contents of the R/W media. Host computer 200, 300, 400 then begins to run the instructions which have been stored in its memory.

In the local mode, any required data, applications and user preferences must all reside on the R/W media.

In the networked mode, host computer 200, 300, 400 may then be directed to run, or automatically run a communication program stored on the R/W media to create a remote link to a server 500. Server 500 may be a single computer, or a group of computers linked to perform parallel processing referred to as a “cluster”.

The link between host computer 200, 300, 400 may be a hardwired link 610, a radiofrequency data link 620, an optical fiber link, a cable and cable modem link, or other data communication link, (not shown) or combinations of these.

Since some operating systems are more resistant to intentional data destruction and data theft, and also are less susceptible to infection by viruses, worms, Trojan horses, adware, spyware and other Internet microbes than others, it is preferred that the more resistant, less susceptible operating systems be used. The Linux Operating system would be a preferred choice. However, it is to be understood that other operating systems may also be used which will fall under the scope of this invention.

Networked Mode—Initial Setup

These steps are performed the first time a user begins to use the present invention in the networked mode.

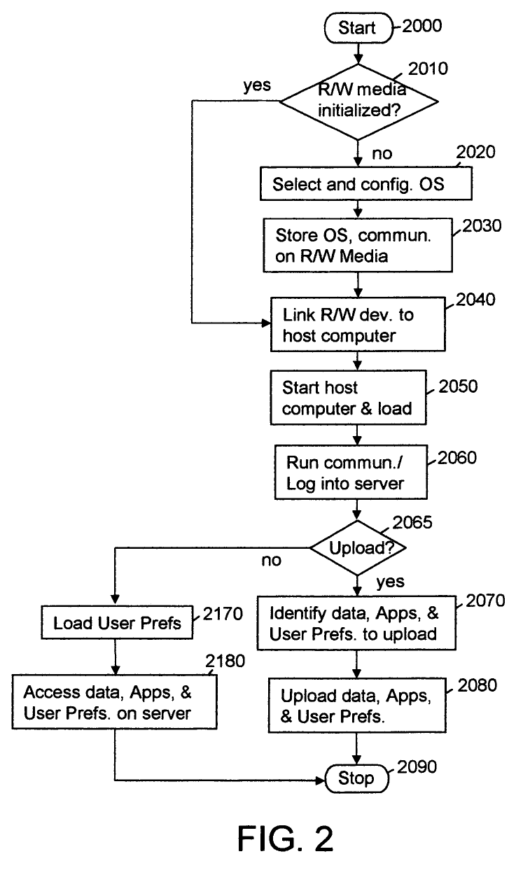

1. The process starts at step 2000 of FIG. 2.

2. It is determined if the R/W media has been configured in step 2010.

3. If the R/W media has been initialized (“yes”), then processing continues at step 2040. If the R/W media has not been initialized (“no”), the process continues at step 2020.

4. In step 2020 an operating system (“OS”) is selected and configured to allow a user to a) prohibit writing to the host computer local drives and perform all of its writing on the R/W media, or b) allow writing to the host computer local drives and the R/W media.

5. The configured OS and selected communications software are stored on the R/W media to initialize it in step 2030.

6. The R/W media is inserted/attached/linked to a host computer as is appropriate in step 2040. This step is performed after step 2010 upon subsequent uses with R/W media that has been previously initialized.

7. The host computer is started, senses the R/W media and automatically loads the configured OS onto the host computer in step 2050.

8. The user runs the communications programs and logs into a remote server in step 2060.

9. In step 2065 it is determined if information is to be uploaded to the remote server, such as during the initial setup. If no information is intended to be uploaded (“no”), then steps 2170 and 2180 are performed. If there is information intended to be uploaded (“yes”), then processing continues at step 2070.

10. In step 2070, the user identifies Apps. that are compatible and may be run on the configured OS, data and User Prefs to be uploaded to a remote server (500 of FIG. 1). The user also specifies when an upload should occur, either immediately or at some other scheduled time/date.

11. The remote server uploads the indicated data, Apps, User Prefs, etc. at the scheduled time/date in step 2080.

12. The initial setup ends at step 2090.

Networked Mode—Subsequent Uses

The steps 2000 through 2065 are performed as described above in the section entitled “NETWORKED MODE—INITIAL SETUP”.

If it is determined in step 2065 that this is a subsequent use and that the proper files have already been uploaded, the following steps are performed.

13. The server identifies the user, the users data, Apps, and User Prefs, etc. and loads the User Prefs in step 2170 giving the user same familiar ‘look and feel’ on any host computer used.

14. The uploaded data, Apps and User Prefs are now accessible to the user in step 2180.

15. When the user is finished, the process ends at step 2090.

Since the same User Prefs are loaded each time, the look and feel of the system from one host computer to another should appear the same, regardless of which host computer the user is operating.

Please note that files may be uploaded any time, however, most of the file uploads occur during the initial setup.

Optionally, firewall programs and other utility programs may be stored on the R/W media to reduce the viruses and unauthorized access.

When the user shuts down, the host computer remains unchanged since the present invention is designed to not write anything on the host computer local storage devices.

Local Mode—Initial Setup

These steps are performed the first time a user begins to use the present invention in the local mode.

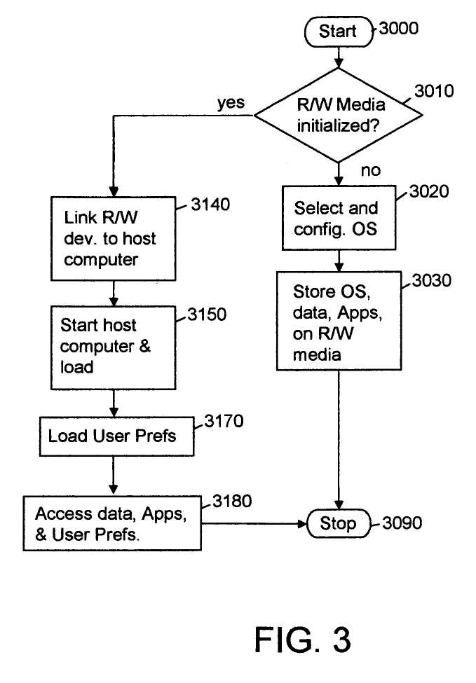

1. The process starts at step 3000 of FIG. 3.

2. It is determined if the R/W media has been configured in step 3010.

3. If the R/W media has been initialized (“yes”), then processing continues at step 3140. If the R/W media has not been initialized (“no”), then processing continues at step 3020.

4. In step 3020 an operating system (“OS”) is selected and configured to allow a user to a) prohibit writing to the host computer local drives and perform all of its writing on the R/W media, or b) allow writing to the host computer local drives and the R/W media.

5. The configured OS and selected data and Apps are stored on the R/W media in step 3030.

6. The initial setup ends at step 3090.

Local Mode—Subsequent Uses

If it is determined in step 3010 the R/W media has been configured (“yes”), the following steps are performed.

7. The R/W media is inserted/attached/linked to a host computer as is appropriate in step 3140.

8. The host computer is started, senses the R/W media and automatically loads the configured OS onto the host computer in step 3150.

9. The User Prefs are loaded from the R/W media in step 3170 giving the same familiar ‘look and feel’.

10. User may now access the data, Apps, User Prefs, etc. previously stored on the R/W drive in step 3180.

11. When the user is finished, the process ends at step 3090.

Since the same User Prefs are loaded each time, the look and feel of the system from one host computer to another should appear the same, regardless of which host computer the user is operating.

The present invention therefore allows the user access to his/her data, apps, and user-defined preferences in a standard format from virtually any host computer.

If the user has opted to prohibit writing to the host computer local storage devices, then after use, the host computer remains unchanged since the present invention is designed to not write anything on the host computer local storage devices.

Advantages

Since the data/Apps/User Prefs are not stored locally, but are stored on a server, there is little chance of accidental data loss.

Since the data/Apps/User Prefs are not stored locally, but are stored on a server, there is little chance of data theft by remote or local means.

Since the data/Apps/User Prefs are not stored locally, but are stored on a server, they can be accessed from anywhere.

Since user-defined preferences are not stored locally, but are stored on a server, they do not need to be entered every time the user operates a different host computer.

Since apps are stored at a central location, one copy of an app may be stored instead of multiple copies on each user's PC. This saves overall disk space and cost.

Since the configured OS is pre-stored on the R/W media and is loaded onto every host computer used, there are no compatibility problems with the server and the configured OS.

Since the configured OS and user preferences are pre-stored on the R/W media and are loaded onto every host computer used, the user will be familiar with the system and not require additional training or familiarization

Implementations

Corporate Disaster Recovery

The present invention has a variety of uses. For example, the present invention may be used as a disaster recovery system.

Initially, the system server uploads all info, operating systems, Apps, User Prefs, data, including the obsolete versions of Apps, or obsolete Apps from a corporate system intended to be protected.

The present invention then either performs periodic updates of all uploaded info, or performs continuous updates of (“mirrors”) the protected system until there is a computer malfunction.

When a computer malfunction occurs, users at corporate system may then insert the R/W media into their personal computer, linking them to the server according to the present invention. This will have a complete mirror of the corporate information. Users may then continue where they left off with the mirror server, even if their local computer system has crashed.

Data and Application Backup

Another implementation is to store data along with the corresponding version of a compatible application on the server. This may include backing up a single copy of a current application (which may be used by many users to save space) or saving rare or obsolete applications which correspond to the user data.

A user may access the data using the R/W media and run it with the proper application.

Applicatoin Archiving

The present invention may also be implemented by archiving obsolete applications onto the server. These may be available by logging onto the server using the present invention.

What is claimed is:

1. A method of accessing a user's information in a consistent manner from a host computer having local storage drives, comprising the steps of:
a) providing removable read/write media (“R/W media”) configured with a “bootable” operating system that does not write to the host computer's local storage devices, but instead writes to the R/W media;
b) activating a data link during startup of the host computer between the R/W media and the host computer causing the contents of the R/W media to be loaded into memory of the host computer;
c) running the operating system loaded into the memory of the host computer to ‘boot up’ the host computer; and
d) accessing the user's information.

2. The method of claim 1 wherein the step of providing removable R/W media configured with a “bootable” operating system” comprises the steps of
a) selecting an operating system;
b) configuring the selected operating system to allow a user to prohibit writing to said local storage device and perform its writing the R/W media; and
c) storing the configured operating system on the R/W media at a specific start location from which the host computer is configured to load its memory, making the operating system bootable.

3. The method of claim 2 wherein the specific start location comprises of one of the group consisting of a track/sector, hardware address, and memory location.

4. The method of claim 1 wherein the step of accessing the user's information comprises the steps of:
a) running communications software to link the host computer to a server having the user's information that was previously stored on the server; and
b) logging onto the server to access the user's information.

5. The method of claim 1 wherein the user's information comprises one of the group consisting of:
computer applications programs, user data, and user-defined preferences for applications.

6. The method of claim 1, wherein the step of activating a data link comprises activating one of the group consisting of a USB port, a radiofrequency data link, and an infrared data link.

7. The method of claim 2 wherein the step of storing the configured operating system on R/W media comprises storing an operating system on rewritable media selected from the group consisting of:
CDRW, DVD-RW, memory drives, holographic memory, molecular memory, and quantum memory.

8. The method of claim 2 wherein the step of storing an operating system on the R/W media comprises the step of:
storing an operating system on a memory drive having wherein at least a portion of the operating system is stored on read-only memory.

9. The method of claim 2 wherein the step of storing an operating system on the R/W media comprises the step of:
storing a general operating system on the R/W media which is specifically designed to resist network attacks.

10. The method of claim 2, wherein the operating system is selected to be a version of Linux.

11. The method of claim 2, further comprising the step of:
storing user preference of a user on the R/W media.

12. The method of claim 1 wherein the user's information includes data.

13. The method of claim 1 wherein the user's information includes applications programs.

14. The method of claim 1 wherein the user's information includes user preferences.

15. A method of configuring removable read/write media (“R/W media”) which may be used to load a portable operating system on a host computer comprising the steps of:
a) providing R/W media capable of storing digital information provided to it;
b) configuring an operating system so it does not write to the host computer's storage devices, but instead writes to the R/W media;
c) providing the configured operating system to the R/W media so as to store the configured operating system at a specific boot location designated as a start location from which the host computer loads its memory, making the operating system bootable.

16. The method of claim 15 wherein the step of activating a data link comprises activating one of the group consisting of:
a USB port, a radiofrequency data link, and an infrared data link.

17. The method of claim 15 wherein the step of storing an operating system on R/W media comprises storing an operating system on rewritable media selected from the group consisting of:
CDRW, DVD-RW, memory drives, holographic memory, molecular memory, and quantum memory.

18. The method of claim 15 wherein the step of storing an operating system on the R/W media comprises the step of:
storing an operating system on a memory drive having at least a portion of the operating system stored on read-only memory.

19. The method of claim 15 wherein the step of storing an operating system on the R/W media comprises the step of:
storing a general operating system on the R/W media which is specifically designed to resist network attacks.

20. The method of claim 15, wherein the operating system is chosen to be a version of Linux.

21. The method of claim 15 further comprising the step of:
storing user preferences of a specific user on the R/W media.

22. The method of claim 15 further comprising the step of:
storing communications software capable of linking a host computer to a server on the R/W media.

23. The method of claim 15 further comprising the step of:
storing on the R/W media at least one of the group consisting of:
computer applications programs, user data, and user-defined preferences for applications.

24. An access device for allowing use of a host computer without changing the contents of the computer comprising:
a) removable read/write media capable of storing and providing digital information provided to it (“R/W media”);
b) a data link in data communication with the R/W media, capable of passing data to, and receiving data from the host computer;
c) an operating system configured to preclude writing to the host computer's storage devices, and configured to write on the R/W media, the configured operating system pre-stored on the R/W media beginning at a location from which the host computer begins loading its internal memory upon start-up, making the operating system bootable.

25. The access device of claims 24 wherein the R/W media comprises rewritable media selected from the group consisting of:
CDRW, DVD-RW, memory drives, holographic memory, molecular memory, and quantum memory.

26. The access device of claims 24 wherein the R/W media comprises a memory drive having at least a portion of the operating system stored on read-only memory.

27. The access device of claim 24 wherein the data link comprises one of the group consisting of:
a USB port, a radiofrequency data link, and an infrared data link.

28. The access device of claim 24 wherein the operating system is chosen to be a standard operating system which is resistant to network attacks.

29. The access device of claim 24 wherein the operating system is chosen to be a version of Linux operating system.

30. The access device of claim 24 wherein user preferences of a specific user are pre-stored on the R/W media.
